(19) United States
(12) Patent Application Publication
(10) Pub. No.: US 2010/0156198 A1
(43) Pub. Date: Jun. 24, 2010

(54) SHIELD LAYER PLUS REFRIGERATED BACKSIDE COOLING FOR PLANAR MOTORS

(76) Inventors: Alexander Cooper, Belmont, CA (US); Scott Coakley, Belmont, CA (US); Douglas C. Watson, Campbell, CA (US); Alton H. Phillips, East Palo Alto, CA (US); Gaurav Keswani, Fremont, CA (US); Michael B. Binnard, Belmont, CA (US)

Correspondence Address: Technology & Innovation Law Group, PC;Attn: 1401, 19200 Stevens Creek Blvd, Suite 240, Cupertino, CA, 95014, US

(21) Appl. No.: 12/643,888

(22) Filed: Dec. 21, 2009

Related U.S. Application Data
(60) Provisional application No. 61/140,042, filed on Dec. 22, 2008.

(51) Int. Cl. H02K 9/20; H02K 41/03

(52) U.S. Cl. 310/12.06; 310/12.29

(57) ABSTRACT

According to one aspect of the present invention, a motor arrangement includes at least one coil, a cover plate, and a shield layer. The at least one coil has a first side and a second side. The cover plate is positioned substantially over the first side of the at least one coil at a distance from the at least one coil. The shield layer is positioned between the first side of the at least one coil and the cover plate, and has a top surface. The top surface contacts the cover plate, and includes a liquid and a gas that form a mixture and cause the top surface to have a substantially constant temperature.

### CROSS-REFERENCE TO RELATED APPLICATION

The present invention claims priority of U.S. Provisional Patent Application No. 61/140,042, filed Dec. 22, 2008, which is incorporated herein by reference in its entirety.

### BACKGROUND OF THE INVENTION

1. Field of the Invention

The present invention relates generally to semiconductor processing.

2. Description of the Related Art

Current supplied to motors used in photolithography equipment, e.g., motors included in a reticle stage assembly and/or a wafer stage assembly, generate heat that is subsequently transferred to a surrounding environment. An increase in heat may adversely affect the accuracy of a photolithography process. For example, a positioning accuracy of an exposure apparatus may be compromised.

Planar motors which are used in semiconductor processing equipment such as a photolithography apparatus often generate a significant amount of heat. By way of example, when a planar motor moves, the coils in the planar motor generally generate a relatively large amount of heat. That is, active coils are relatively hot. When the heat generated by a planar motor reaches critical components in semiconductor processing equipment, the performance of those components and, hence, the semiconductor processing equipment may be adversely impacted. That is, some components in semiconductor processing equipment are temperature-sensitive and, thus, the performance of such components may be adversely affected when heat emanating from planar motors changes the temperature of such components.

To reduce the amount of heat reaching temperature-sensitive components, cooling techniques may be applied to planar motors. As will be understood by those skilled in the art, cooling may also be needed to prevent coils from damaging themselves due to overheating. Coolant may be used to absorb some of the heat generated by planar motors. However, because of the relatively large quantities of heat generated by planar motors, large coolant flow rates and large temperature rises in coolant are likely if the coolant is to be successful in cooling the planar motors. Large flow rates are often problematic due to space constraints associated with planar motors, and large coolant temperature rises are generally unacceptable due to temperature stability requirements. As such, using coolant with large coolant flow rates to cool planar motors may be ineffective for planar motors that are used in systems with temperature-sensitive components.

### SUMMARY OF THE INVENTION

The present invention pertains to cooling a motor, e.g., a planar motor, used in a system in which undesirable heat may be generated, e.g., a lithography system. The present invention may be implemented in numerous ways, including, but not limited to, as a method, system, device, or apparatus. Example embodiments of the present invention are discussed below and are provided for purposes of illustration, and not for purposes of limitation.

According to one aspect of the present invention, a motor arrangement includes at least one coil, a cover plate, a shield layer, and a coolant supply. The at least one coil has a first side and a second side, while the cover plate is positioned substantially over the first side of the at least one coil at a distance from the at least one coil. The shield layer is arranged between the first side of the at least one coil and the cover plate, and contacts the cover plate. The shield layer is configured to maintain the cover plate at a substantially uniform cover plate temperature. Finally, the coolant supply is arranged to provide a coolant to the second side of the at least one coil. The coolant supply provides the coolant at a coolant temperature that is approximately lower than the substantially uniform cover plate temperature.

In one embodiment, the at least one coil includes coils that are intermittently active, or that produce different amounts of heat. In such an embodiment, a first coolant supply is configured to provide a first coolant to the coil(s) producing more heat and a second coolant to the coil(s) producing less heat.

According to another aspect of the present invention, a method of cooling a motor that has at least one coil with a first side and a backside, and a cover plate positioned at a distance from the first side of the at least one coil, includes providing at least one coolant to the at least one coil. The coolant is provided from the backside of the at least one coil. The method also includes providing a mixture between the cover plate and the first side of the at least one coil. The mixture includes a liquid and a gas, and contacts a first surface of the cover plate. The mixture substantially indirectly causes a second surface of the cover plate to maintain an approximately constant and uniform temperature, as for example by causing the first surface to maintain a substantially uniform temperature. Finally, the method includes maintaining a shield layer between the cover plate and the first side of the at least one coil. The shield layer includes the mixture.

In one embodiment, the at least one coil includes groups of coils which may have different cooling requirements. By way of example, the at least one coil may include an active coil and an idle coil, and the method includes identifying the active coil, identifying the idle coil, providing a first coolant to the active coil, and providing a second coolant to the idle coil. In another embodiment, the coolant is a liquid coolant that is included in the shield layer.

### BRIEF DESCRIPTION OF THE DRAWINGS

The invention will be readily understood by the following detailed description in conjunction with the accompanying drawings, in which:

FIG. 1 is a block diagram representation of a planar motor in accordance with an embodiment of the present invention.

FIG. 2 is a block diagram representation of a two-phase shield layer associated with a motor in accordance with an embodiment of the present invention.

FIG. 3 is a diagrammatic representation of a system in which coolant is provided to coils of a planar motor in accordance with an embodiment of the present invention.

FIG. 4 is a diagrammatic representation of temperatures associated with a cover plate included in a planar motor in accordance with an embodiment of the present invention.

FIG. 5 is a process flow diagram which illustrates a method of cooling a mover such as a planar motor in accordance with an embodiment of the present invention.

FIG. 6 is a diagrammatic representation of a photolithography apparatus in accordance with an embodiment of the present invention.

FIG. 7 is a process flow diagram which illustrates the steps associated with fabricating a semiconductor device in accordance with an embodiment of the present invention.

FIG. 8 is a process flow diagram which illustrates the steps associated with processing a wafer, i.e., step 604 of FIG. 7, in accordance with an embodiment of the present invention.

### DETAILED DESCRIPTION OF THE INVENTION

Example embodiments of the present invention are discussed below with reference to the various figures. However, those skilled in the art will readily appreciate that the detailed description given herein with respect to these figures is for explanatory purposes, as the invention extends beyond these embodiments.

To assure the performance of semiconductor processing equipment, planar motors associated with the semiconductor processing equipment are cooled. Because of space constraints in a planar motor, as well as other factors such as power level requirements, maintaining a constant temperature against a cover plate of the planar motor is generally difficult. By creating a shield layer within a planar motor that has a mixture of liquid and gas, a substantially constant temperature may be maintained at a top portion of the shield layer, e.g., at a portion of the shield layer which abuts or otherwise effectively comes into contact with a cover plate. Such a two-phase shield layer cools and heats the cover plate such that a substantially constant temperature may be maintained on a lower side or bottom of the cover plate. Alternatively, the shield layer may be a laminar flow of a liquid layer that substantially prevents heat from the planar motor from reaching the cover plate. As such, a relatively uniform surface temperature may be substantially maintained on an upper side or top of the cover plate. It should be appreciated that although a “top” side and a “bottom” side are described, such sides are described as being a top and a bottom for purposes of illustrations. Sides are not limited to be top and bottom sides and may be, for example, a left side and a right side.

Coolant, as for example cold coolant, may be applied from below, or from one side of, a planar motor such that heat may be removed from below the planar motor. As temperature fluctuations are less critical below a motor than above, or from a different side of, a motor, e.g., where relatively temperature sensitive components may be positioned, any temperature rises in the coolant as a result of heat transfer from active coils of the motor may generally not adversely impact the temperature near a top portion of a shield layer. That is, on a side of a motor that is effectively away from temperature sensitive components, coolant at a temperature that is colder than or lower than an ambient temperature may be used to provide cooling as temperature stability is less critical.

Cooling a planar motor may include the use of a bulk coolant supplied and extracted from underneath coils, and the use of a shield layer. A bulk coolant may extract a relatively large amount of heat, and the use of a shield layer significantly reduces the need to control or insulate the bulk coolant system, and instead utilizes the shield layer to provide a substantially uniform temperature. Such a bulk cooling system may supply and extract its coolant away from temperature sensitive areas, thereby further reducing the need to carefully control or insulate the components of the bulk cooling system.

In one embodiment, a shield layer may be used with a cooling system that provides coolant at different temperatures to a backside of a planar motor. Different areas of a planar motor may be controlled and supplied with coolant depending upon the amount of heat generated by the different areas of the planar motor. The shield layer allows a substantially uniform temperature to be maintained in a cover plate. The shield layer may be laminar or non-laminar, i.e., single phase or two phase.

By using relatively cold coolant from below, a significant amount of the heat in a motor may be removed from the lower side of the motor, e.g., from underneath the motor. An initially cold coolant applied from below, and a subsequent temperature rise, may be acceptable since the fluid may be supplied and removed from below where temperature fluctuations are generally less critical.

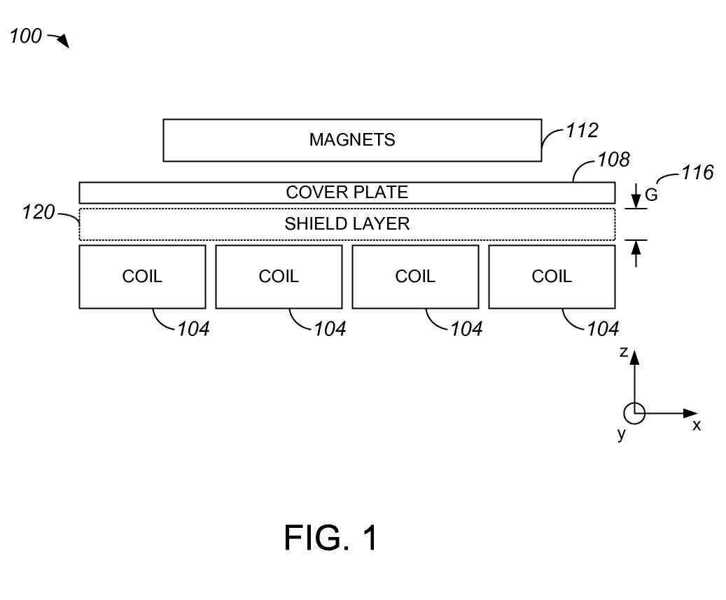

FIG. 1 is a block diagram representation of a planar motor in accordance with an embodiment of the present invention. A planar motor 100 includes a plurality of coils 104, a cover plate 108, and an array of magnets 112. It should be appreciated that although planar motor 100 is shown as being one-sided, planar motor 100 may instead be two-sided. It should be appreciated that although a planar motor is described, a motor may instead be a linear motor without departing from the spirit or the scope of the present invention. Cover plate 108 is typically positioned above coils 104. Array of magnets 112 are arranged to move over cover plate 108. In other words, magnets 112 may be arranged to be substantially magnetically levitated over cover plate 108. However, magnets 112 are not limited to being substantially magnetically levitated. By way of example, magnets 112 may instead be coupled to a bearing arrangement (not shown).

Cover plate 108 is positioned such that there is a gap “G” 116, e.g., spacing, between coils 104 and cover plate 108. In general, the size of gap “G” 116 is as small as possible because the performance of planar motor 100 is improved when array of magnets 112 is closer to coils 104. That is, for motor performance reasons, the height of gap “G” 116 is preferably substantially minimized. Hence, the height of gap “G” 116 is preferred to be as close to approximately zero inches as possible. By way of example, the height of gap “G” 116 may be approximately one millimeter (mm), although it should be appreciated that the height of gap “G” 116 may vary widely. In general, the height of gap “G′ 116 may be much less than approximately one cm.

Generally, the height of gap “G” 116 may be chosen to allow for the cooling of coils 104, e.g., such that coolant may flow over the tops of coils 104. Gap “G” 116 is sized to enable a shield layer 120 to form between coils 104 and cover plate 108. Shield layer 120 is formed from a mixture of liquid and gas, and is arranged to substantially maintain an approximately constant and uniform temperature near a top of shield layer 120 and, hence, at a bottom of cover plate 108. That is, shield layer 120 is a two-phase shield layer in the described embodiment. Shield layer 120 is arranged to protect sensitive components (not shown) that may be positioned above shield layer 120. It should be appreciated, however, that shield layer 120 is not limited to being a two-phase shield layer, and may instead be a laminar or single phase shield layer.

Shield layer 120 may, in one embodiment, be separated from substantially any flow from below coils 104 to substantially prevent the flow from interfering with shield layer 120. There may be a divider (not shown) positioned substantially above coils 104 that effectively keeps shield layer 120 separate from a cooling flow. Such a divider (not shown) may be attached to the top surface of coils 104. In one embodiment, such a divider (not shown) is preferably made from a thermally insulating material.

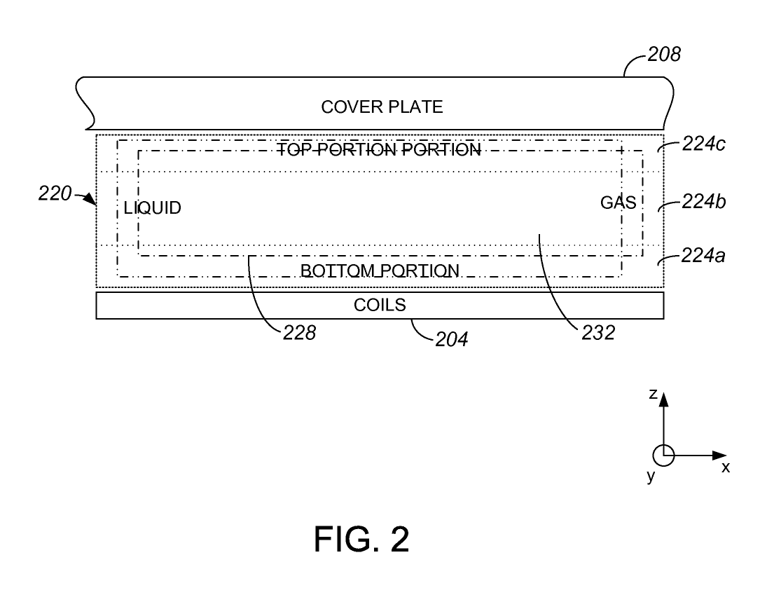

Referring next to FIG. 2, a two-phase shield layer will be described in accordance with an embodiment of the present invention. A two-phase shield layer 220 is generally present between a cover plate 208 and coils 204. The size of two-phase shield layer 220 relative to cover plate 208 and coils 204 has been exaggerated for purposes of illustration. In general, cover plate 208 may have a thickness of approximately two mm or less.

When coolant is provided to cool coils 204, the coolant is provided from a backside, e.g., bottom, of coils 204. When coolant comes into contact with coils 204, heat is transferred from coils 204 to the coolant, and the heat is effectively removed from coils 204. In one embodiment, flow from underneath coils 204 may be substantially separated from shield layer 220 using a divider (not shown) such that there is effectively a layer of coolant (not shown) between or above the coils, the divider, then shield layer 220.

An interface layer 224b of shield layer 220 is generally arranged to form a border between bottom portion 224a of shield layer 220 and a top portion 224c of shield layer 220. It should be appreciated that bottom portion 224a and top portion 224c are generally areas of two-phase shield layer that come into contact with coils 204 and cover plate 208, respectively. Shield layer 204 may be provided with or otherwise supplied with both liquid 228 and/or gas 232, e.g., liquid coolant and gas coolant. Hence, at least constant temperature portion 224c may include both liquid 228 and gas 232.

In the presence of a substantially controlled pressure, liquid 228 and gas 232 cooperate, e.g., equilibrate, to effectively provide a substantially constant temperature to cover plate 208. In other words, top portion 224c contacts cover plate 208 such that a constant temperature is effectively maintained against cover plate 208. The constant temperature may be maintained when there is a mixture of liquid 228 and gas 232 to provide cooling by evaporation, and warming by condensation.

As previously mentioned, coolant may be provided to a backside of coils, or from underneath coils, such that heat may, for example, be removed from underneath a mover or motor. Such coolant may be at two different temperature such that a colder coolant may be applied to active coils while a warmer coolant may be applied to idle or inactive coils. It should be appreciated that although active and idle coils are described, colder coolant may generally be applied to warmer coils and warmer coolant may generally be applied to cooler coils. The two different input coolant temperatures may be used substantially simultaneously. That is, a lower coolant temperature may be used on active coils substantially at the same time that a higher coolant temperature may be used on idle coils. It should be understood, however, that in lieu of coolants at different temperatures, coolants of the same temperature may be applied to the backside of coils. In general, a coolant supply arrangement may be configured to supply coolants at different temperatures, to vary the temperature of a coolant supplied to coils, and/or to supply a coolant of a single temperature.

Supplying two or more different temperature coolants may be simpler to accomplish than having a continuously variable input temperature capability for one coolant, although the one coolant may be used to cool both active and inactive coils. The use of two or more different temperature coolants allows coolant to be supplied differently to the different areas of a motor depending on, but not limited to depending on, the heat generated in each area of the motor. It should be appreciated, however, that coolants are not limited to being supplied differently to the different areas of a motor. In one embodiment, a temperature of coolant removed from a coil arrangement may be measured, and subsequently used to adjust or otherwise control the temperature of coolant provided to the coil arrangement in order to maintain an approximately average temperature of the coil arrangement at a substantially constant, desired temperature.

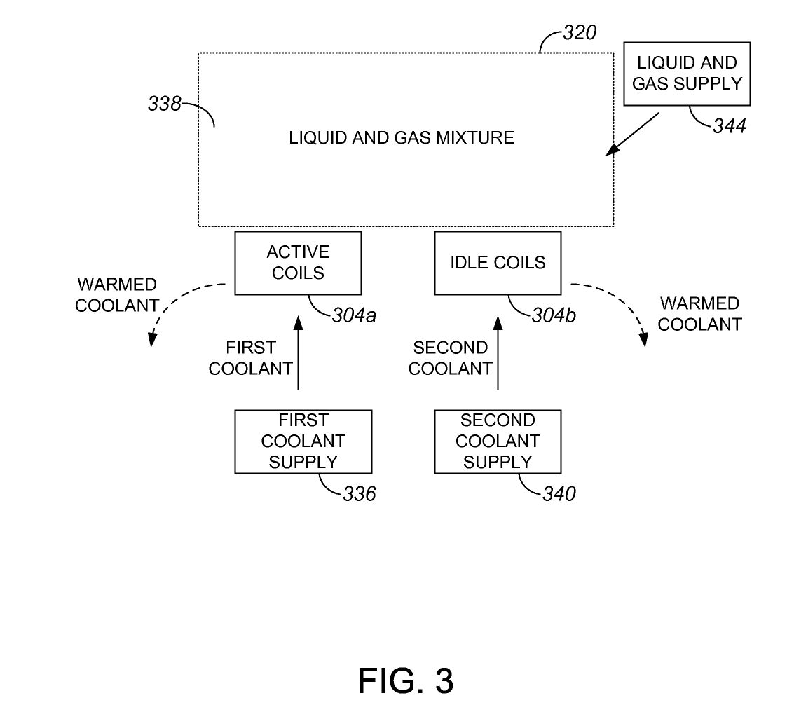

With reference to FIG. 3, a system in which coolant is provided to a backside of coils will be described in accordance with an embodiment of the present invention. Active coils 304a of a planar motor generate heat while active and, as a result, are typically warmer than idle coils 304b. It should be appreciated that during the course of operating a planar motor, active coils 304a and idle coils 304b are effectively constantly changing. A first coolant supply 336 is arranged to provide a first coolant from underneath active coils 304a to cool active coils 304a. A second coolant supply 340 is arranged to provide a second coolant from underneath idle coils 304b to cool idle coils 304b as needed. Warmed coolant, or coolant that is warmed when heat is transferred from coils 304a, 304b, is removed from substantially underneath coils 304a, 304b.

First coolant and second coolant may generally be any suitable liquid coolant. Suitable liquid coolants include, but are not limited to including, water, refrigerants, liquid nitrogen, and liquid helium. It should be understood that although first coolant and second coolant are generally the same type of coolant, first coolant and second coolant may instead be different types of coolants. In one embodiment, first coolant and second coolant are substantially the same coolant, but at different temperatures.

In the described embodiment, first coolant supply 336 supplies a first coolant that is at a lower temperature than a second coolant supplied by second coolant supply 340. By providing a colder coolant to active coils 304a and a warmer coolant to idle coils 304b, the overcooling of idle coils 304b may effectively be minimized. In addition, the amount of shielding that is needed from shield layer 320 may also be substantially minimized. The temperatures of the first and second coolants may vary. A first coolant may, for example, be at a temperature of approximately one degree Celsius while a second coolant may be at a temperature of approximately twenty-two degrees Celsius. The first coolant may generally be at a temperature that is between approximately zero degrees Celsius and approximately twenty degrees Celsius cooler than the second coolant. It should be appreciated that the ranges of temperatures provided are exemplary, and may vary depending upon the composition of the coolants and the specific application.

A liquid and gas mixture 338 is provided, as for example by a liquid and gas supply 344, to shield layer 320. Liquid and gas supply 344 may provide a liquid coolant and/or a gas coolant. Pressure may be controlled in shield layer 320 such that liquid and gas mixture 336 may be maintained in shield layer 320, and such that a substantially constant temperature may be maintained in at least an upper or top portion of shield layer 320. The substantially constant temperature may be any temperature that is suitable for a particular environment. By way of example, the substantially constant temperature may be approximately twenty degrees Celsius.

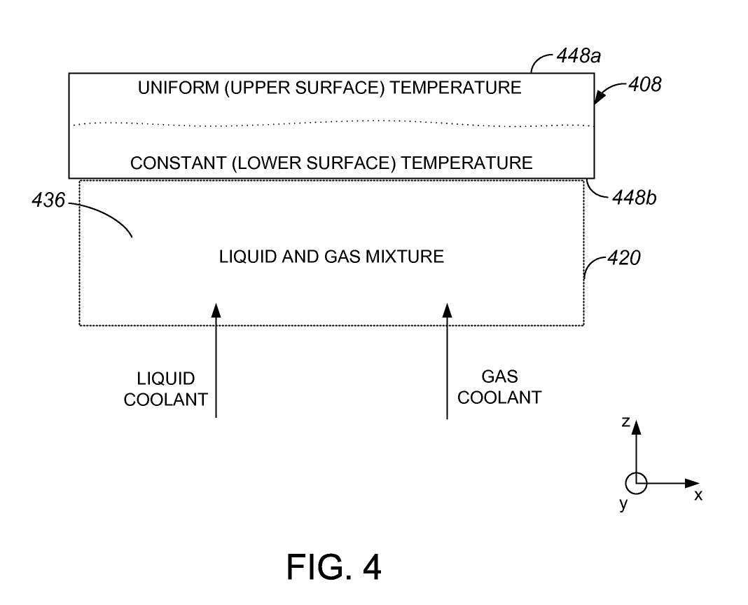

FIG. 4 is a diagrammatic representation of temperatures associated with a cover plate included in a planar motor in accordance with an embodiment of the present invention. A liquid and gas mixture 436 that is provided to a shield layer 420 allows shield layer 420 to both heat and cool a cover plate 408. Liquid and gas mixture 436 fills shield layer 420. Liquid and gas mixture 436 maintains an approximately constant temperature at a lower surface 448b of cover plate 408, and enables a substantially uniform and approximately constant surface temperature at an upper or top surface 448a of cover plate 408. As upper surface 448a of cover plate 408 is typically in close proximity to heat-sensitive components (not shown), e.g., components in a photolithography apparatus, maintaining a substantially uniform and approximately constant surface temperature on upper surface 448a may effectively protect such heat-sensitive components.

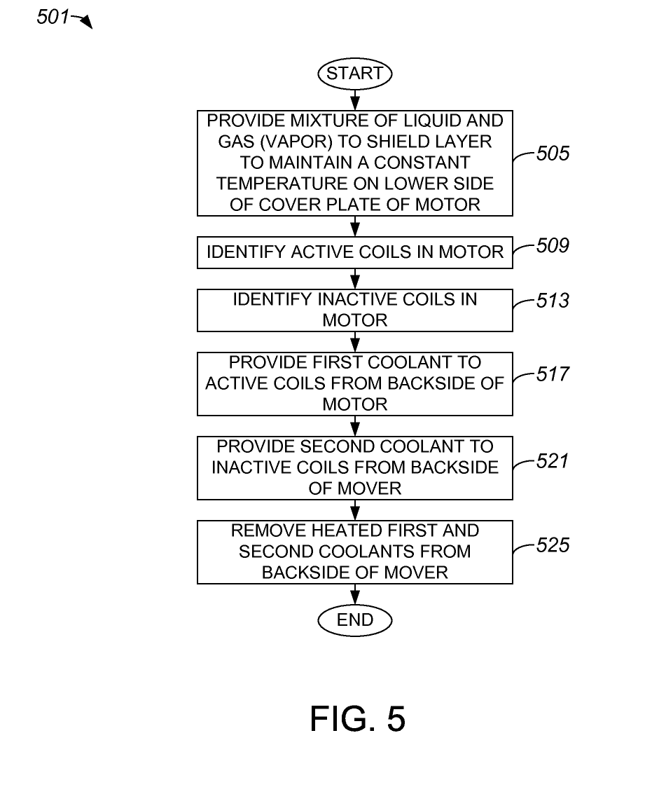

Referring next to FIG. 5, a method of cooling a planar motor will be described in accordance with an embodiment of the present invention. A method 501 of cooling a planar motor begins at step 505 in which a mixture of liquid and/or gas, or vapor, is provided to a shield layer within the planar motor positioned approximately between coils of a mover and a cover plate of the mover. The shield layer, as previously described, may alternatively be a laminar flow shield layer, which contains a substantially laminar flow of liquid coolant instead of a mixture of liquid and vapor. The liquid and/or gas coolant is provided, and pressure in the shield layer is controlled accordingly, to maintain a substantially constant temperature on the lower side of the cover plate.

After the mixture of liquid and gas is provided to the shield layer, active or operating coils in the mover are identified in step 509, and inactive or idle coils are identified in step 513. A first coolant is provided to the active coils from the backside of the mover, e.g., from the bottom of the coils, in step 517. A second coolant is then provided to the inactive coils from the backside of the mover in step 521. Although the first and second coolants may be of the same type and have approximately the same temperature, it should be appreciated that the first coolant may be of a lower temperature than the second coolant, as more heat is generated by the active coils than by the inactive coils. Typically, first and second coolants have substantially the same chemical composition.

Once coolant is provided to the coils, the heated coolant is removed in step 525 from the backside of the planar motor. The removal of the heated coolant effectively removes heat from the coils. In one embodiment, the heated coolant may be removed by a coolant remover associated with a coolant supply. The method of cooling a planar motor is completed upon removing the heated coolant from the backside of the planar motor.

The use of cold coolant substantially underneath a shield layer is permissible, in one embodiment, because the shield layer protects the sensitive components above it, and because the cold and hot coolant may be supplied and removed from below, where temperature variations are less critical.

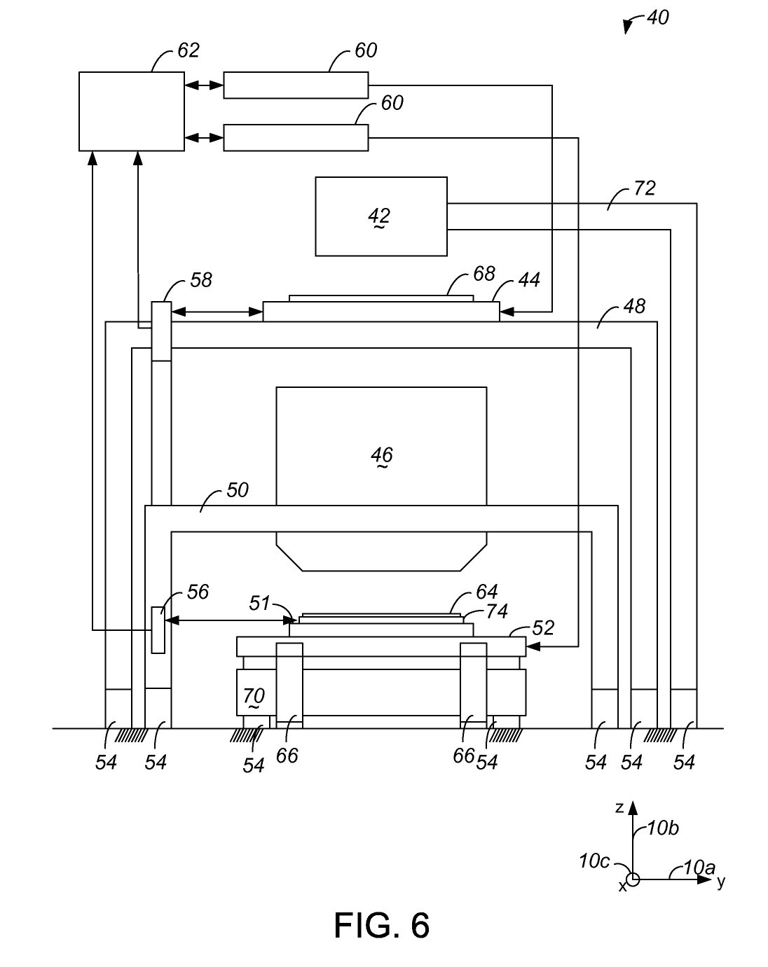

With reference to FIG. 6, one suitable photolithography apparatus which may include planar motors or other actuators which are cooled using a 2-phase shield layer with refrigerated backside cooling will be described in accordance with an embodiment of the present invention. It should be appreciated that the photolithography apparatus described is one example of a suitable photolithography apparatus, and that the components of the apparatus may generally vary. A photolithography apparatus (exposure apparatus) 40 includes a wafer positioning stage 52 that may be driven by a planar motor (not shown), as well as a wafer table 51 that is magnetically coupled to wafer positioning stage 52 by utilizing an EI-core actuator, e.g., an EI-core actuator with a top coil and a bottom coil which are substantially independently controlled. The planar motor which drives wafer positioning stage 52 generally uses an electromagnetic force generated by magnets and corresponding armature coils arranged in two dimensions. The planar motor may be cooled using a 2-phase shield layer described above.

A wafer 64 is held in place on a wafer holder or chuck 74 which is coupled to wafer table 51. Wafer positioning stage 52 is arranged to move in multiple degrees of freedom, e.g., in up to six degrees of freedom, under the control of a control unit 60 and a system controller 62. In one embodiment, wafer positioning stage 52 may include a plurality of actuators and have a configuration as described above. The movement of wafer positioning stage 52 allows wafer 64 to be positioned at a desired position and orientation relative to a projection optical system 46.

Wafer table 51 may be levitated in a z-direction 10b by any number of voice coil motors (not shown), e.g., three voice coil motors. In one described embodiment, at least three magnetic bearings (not shown) couple and move wafer table 51 along a y-axis 10a. The motor array of wafer positioning stage 52 is typically supported by a base 70. Base 70 is supported to a ground via isolators 54. Reaction forces generated by motion of wafer stage 52 may be mechanically released to a ground surface through a frame 66. One suitable frame 66 is described in JP Hei 8-166475 and U.S. Pat. No. 5,528,118, which are each herein incorporated by reference in their entireties.

An illumination system 42 is supported by a frame 72. Frame 72 is supported to the ground via isolators 54. Illumination system 42 includes an illumination source, which may provide a beam of light that may be reflected off of a reticle. In one embodiment, illumination system 42 may be arranged to project a radiant energy, e.g., light, through a mask pattern on a reticle 68 that is supported by and scanned using a reticle stage 44 which includes a coarse stage and a fine stage. The radiant energy is focused through projection optical system 46, which is supported on a projection optics frame 50 and may be supported the ground through isolators 54. Suitable isolators 54 include those described in JP Hei 8-330224 and U.S. Pat. No. 5,874,820, which are each incorporated herein by reference in their entireties.

A first interferometer 56 is supported on projection optics frame 50, and functions to detect the position of wafer table 51. Interferometer 56 outputs information on the position of wafer table 51 to system controller 62. In one embodiment, wafer table 51 has a force damper which reduces vibrations associated with wafer table 51 such that interferometer 56 may accurately detect the position of wafer table 51. A second interferometer 58 is supported on projection optical system 46, and detects the position of reticle stage 44 which supports a reticle 68. Interferometer 58 also outputs position information to system controller 62.

It should be appreciated that there are a number of different types of photolithographic apparatuses or devices. For example, photolithography apparatus 40, or an exposure apparatus, may be used as a scanning type photolithography system which exposes the pattern from reticle 68 onto wafer 64 with reticle 68 and wafer 64 moving substantially synchronously. In a scanning type lithographic device, reticle 68 is moved perpendicularly with respect to an optical axis of a lens assembly (projection optical system 46) or illumination system 42 by reticle stage 44. Wafer 64 is moved perpendicularly to the optical axis of projection optical system 46 by a wafer stage 52. Scanning of reticle 68 and wafer 64 generally occurs while reticle 68 and wafer 64 are moving substantially synchronously.

Alternatively, photolithography apparatus or exposure apparatus 40 may be a step-and-repeat type photolithography system that exposes reticle 68 while reticle 68 and wafer 64 are stationary, i.e., at a substantially constant velocity of approximately zero meters per second. In one step and repeat process, wafer 64 is in a substantially constant position relative to reticle 68 and projection optical system 46 during the exposure of an individual field. Subsequently, between consecutive exposure steps, wafer 64 is consecutively moved by wafer positioning stage 52 perpendicularly to the optical axis of projection optical system 46 and reticle 68 for exposure. Following this process, the images on reticle 68 may be sequentially exposed onto the fields of wafer 64 so that the next field of semiconductor wafer 64 is brought into position relative to illumination system 42, reticle 68, and projection optical system 46.

It should be understood that the use of photolithography apparatus or exposure apparatus 40, as described above, is not limited to being used in a photolithography system for semiconductor manufacturing. For example, photolithography apparatus 40 may be used as a part of a liquid crystal display (LCD) photolithography system that exposes an LCD device pattern onto a rectangular glass plate or a photolithography system for manufacturing a thin film magnetic head.

The illumination source of illumination system 42 may be g-line (436 nanometers (nm)), i-line (365 nm), a KrF excimer laser (248 nm), an ArF excimer laser (193 nm), and an F2-type laser (157 nm). Alternatively, illumination system 42 may also use charged particle beams such as x-ray and electron beams. For instance, in the case where an electron beam is used, thermionic emission type lanthanum hexaboride (LaB6) or tantalum (Ta) may be used as an electron gun. Furthermore, in the case where an electron beam is used, the structure may be such that either a mask is used or a pattern may be directly formed on a substrate without the use of a mask.

With respect to projection optical system 46, when far ultra-violet rays such as an excimer laser are used, glass materials such as quartz and fluorite that transmit far ultra-violet rays is preferably used. When either an F2-type laser or an x-ray is used, projection optical system 46 may be either catadioptric or refractive (a reticle may be of a corresponding reflective type), and when an electron beam is used, electron optics may comprise electron lenses and deflectors. As will be appreciated by those skilled in the art, the optical path for the electron beams is generally in a vacuum.

In addition, with an exposure device that employs vacuum ultra-violet (VUV) radiation of a wavelength that is approximately 200 nm or lower, use of a catadioptric type optical system may be considered. Examples of a catadioptric type of optical system include, but are not limited to, those described in Japan Patent Application Disclosure No. 8-171054 published in the Official gazette for Laid-Open Patent Applications and its counterpart U.S. Pat. No. 5,668,672, as well as in Japan Patent Application Disclosure No. 10-20195 and its counterpart U.S. Pat. No. 5,835,275, which are all incorporated herein by reference in their entireties. In these examples, the reflecting optical device may be a catadioptric optical system incorporating a beam splitter and a concave mirror. Japan Patent Application Disclosure (Hei) No. 8-334695 published in the Official gazette for Laid-Open Patent Applications and its counterpart U.S. Pat. No. 5,689,377, as well as Japan Patent Application Disclosure No. 10-3039 and its counterpart U.S. Pat. No. 5,892,117, which are all incorporated herein by reference in their entireties. These examples describe a reflecting-refracting type of optical system that incorporates a concave minor, but without a beam splitter, and may also be suitable for use with the present invention.

The present invention may be utilized, in one embodiment, in an immersion type exposure apparatus if suitable measures are taken to accommodate a fluid. For example, PCT patent application WO 99/49504, which is incorporated herein by reference in its entirety, describes an exposure apparatus in which a liquid is supplied to a space between a substrate (wafer) and a projection lens system during an exposure process. Aspects of PCT patent application WO 99/49504 may be used to accommodate fluid relative to the present invention.

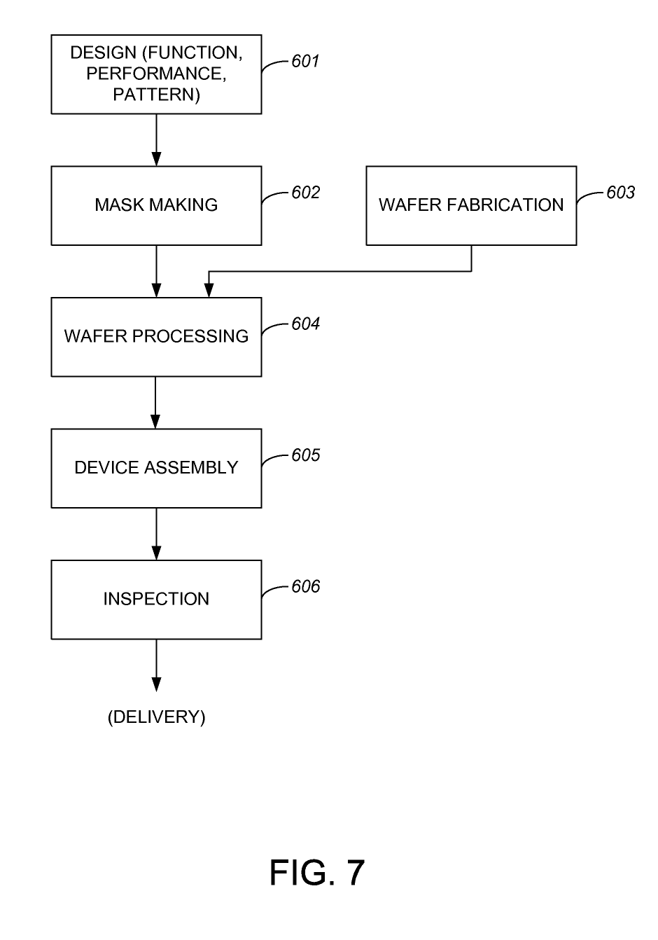

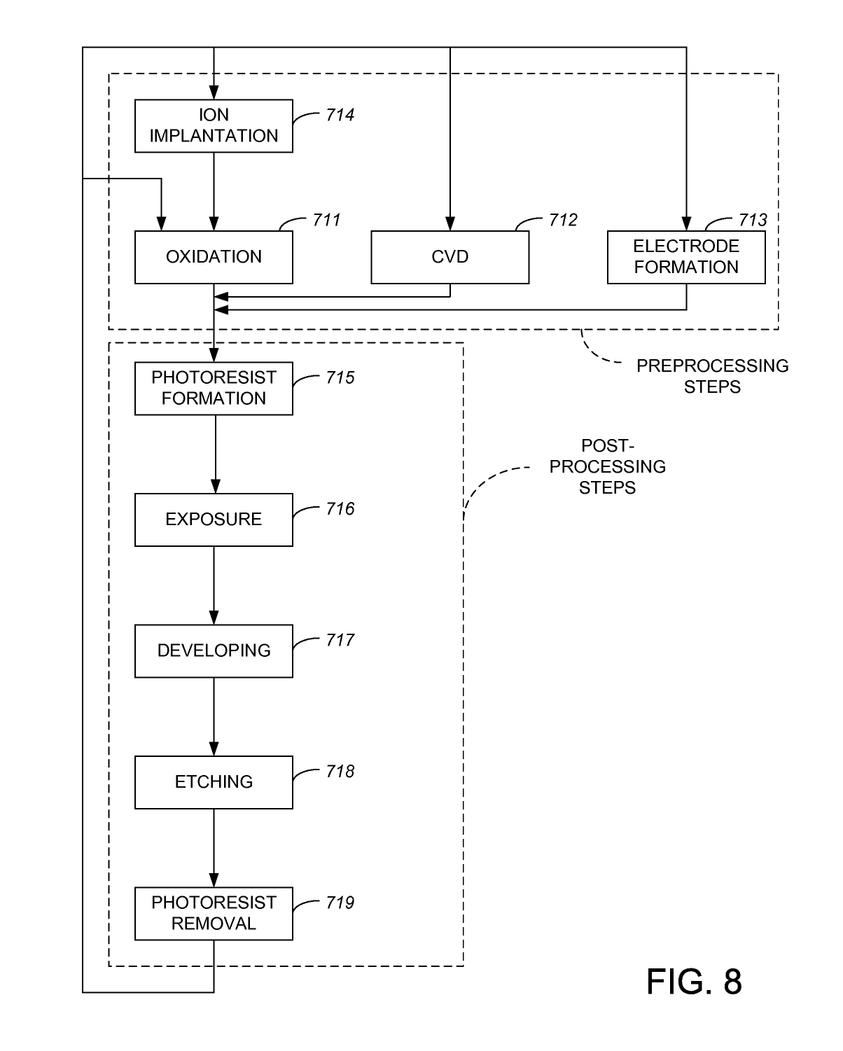

FIG. 7 is a process flow diagram which illustrates the steps associated with fabricating a semiconductor device in accordance with an embodiment of the present invention. A process 601 of fabricating a semiconductor device begins at step 603 in which the function and performance characteristics of a semiconductor device are designed or otherwise determined. Next, in step 605, a reticle or mask in which has a pattern is designed based upon the design of the semiconductor device. It should be appreciated that in a substantially parallel step 609, a wafer is typically made from a silicon material. In step 613, the mask pattern designed in step 605 is exposed onto the wafer fabricated in step 609 through the use of an EUV lithography system. One process of exposing a mask pattern onto a wafer will be described below with respect to FIG. 8. In step 617, the semiconductor device is assembled. The assembly of the semiconductor device generally includes, but is not limited to including, wafer dicing processes, bonding processes, and packaging processes. Finally, the completed device is inspected in step 621. Upon successful completion of the inspection in step 621, the completed device may be considered to be ready for delivery.

FIG. 8 is a process flow diagram which illustrates the steps associated with wafer processing in the case of fabricating semiconductor devices in accordance with an embodiment of the present invention. In step 701, the surface of a wafer is oxidized. Then, in step 705 which is a chemical vapor deposition (CVD) step in one embodiment, an insulation film may be formed on the wafer surface. Once the insulation film is formed, then in step 709, electrodes are formed on the wafer by vapor deposition. Then, ions may be implanted in the wafer using substantially any suitable method in step 713. As will be appreciated by those skilled in the art, steps 701-713 are generally considered to be preprocessing steps for wafers during wafer processing. Further, it should be understood that selections made in each step, e.g., the concentration of various chemicals to use in forming an insulation film in step 705, may be made based upon processing requirements.

At each stage of wafer processing, when preprocessing steps have been completed, post-processing steps may be implemented. During post-processing, initially, in step 717, photoresist is applied to a wafer. Then, in step 721, an exposure device may be used to transfer the circuit pattern of a reticle to a wafer. Transferring the circuit pattern of the reticle of the wafer generally includes scanning a reticle scanning stage which may, in one embodiment, include a force damper to dampen vibrations.

After the circuit pattern on a reticle is transferred to a wafer, the exposed wafer is developed in step 725. Once the exposed wafer is developed, parts other than residual photoresist, e.g., the exposed material surface, may be removed by etching in step 729. Finally, in step 733, any unnecessary photoresist that remains after etching may be removed. As will be appreciated by those skilled in the art, multiple circuit patterns may be formed through the repetition of the preprocessing and post-processing steps.

Although only a few embodiments of the present invention have been described, it should be understood that the present invention may be embodied in many other specific forms without departing from the spirit or the scope of the present invention. By way of example, the use of a shield layer with refrigerated backside cooling has been described as being suitable for a planar motor. It should be appreciated, however, that the use of a shield layer, e.g., either a two-phase shield layer or laminar flow shield layer, with refrigerated backside cooling may be implemented with respect to any suitable mover or motor. Other suitable movers or motors include, but are not limited to including, electric motors such as rotary motors, voice coil motors, linear motors, and/or electromagnetic motors. Further, shield layer with refrigerated backside cooling may be applied to any suitable Freon-based or heating, ventilating, and air conditioning (HVAC) system.

While active and idle, or inactive, coils have generally been described, it should be understood that coils are not limited to being identified as either active or idle. That is, coils may effectively be divided into subsets that will be treated differently, e.g., subsets that will be associated with coolants of different temperatures. For instance, subsets may include, but are not limited to including, coils that are turned on and coils that are turned off, and coils that are located in different physical areas of a planar motor or otherwise. In other words, coils may generally be divided into groups that have substantially different cooling requirements.

In one embodiment, a coolant inlet temperature may be controlled by monitoring an associated outlet temperature. As the outlet temperature rises, the inlet temperature may be adjusted in order to maintain a desired set point, or a desired constant temperature on a surface of a cover plate. Such control may be achieved using a closed loop control system.

As mentioned above, the temperature of a two-phase flow is generally controlled by controlling the pressure in the flow. In general, substantially any method may be used to adjust the pressure in the flow.

A shield layer has been described as either being two-phase or single phase. For a single phase shield layer, temperature shielding may be achieved by flowing a fluid through the shield layer at such a speed that heat is unable to significantly conduct through the thickness of the shield layer before the fluid essentially exits from the shield layer.

One embodiment of the present invention assumes that there is a single coolant loop per coil, and that flow to coils would be switched to flow either one coolant or another coolant through the single coolant loop, as appropriate. It should be understood that a “coolant loop” may be an inlet for each coil and a drain/outlet that is shared by several or all coils such that each coil obtains coolant at a certain temperature determined by how hot the coil is. The obtained coolant flows around that coil and then may combine with coolant from nearby coils before substantially flowing through one or more shared outlets.

When there are two coolants provided to a planar motor, the two coolants may be substantially the same chemically because coils will be switched between one or the other, e.g., when the coils switch from being active to idle. Hence, the coolants may effectively be mixed, at least partially. However, having two chemically different coolants may be achieved, as for example using two coolant loops per coil.

When coolant is supplied, coolant may be supplied such that a single coolant has a single chemical composition but different temperatures, or the coolant may be supplied such different coolants have different chemical compositions. In general, when two coolants are described, the two coolants have the same chemical composition but different temperatures. It should be appreciated, however, that two coolants may instead be coolants with different properties or chemical compositions without departing from the spirit or the scope of the present invention.

The operations associated with the various methods of the present invention may vary widely. By way of example, steps may be added, removed, altered, combined, and reordered without departing from the spirit or the scope of the present invention. For instance, steps of adding and removing coolant from coils of a mover may be performed substantially in parallel, although such steps have been described as occurring approximately sequentially.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A motor arrangement comprising:
at least one coil, the at least one coil having a first side and a second side;
a cover plate, the cover plate being positioned substantially over the first side of the at least one coil at a distance from the at least one coil;
a shield layer, the shield layer being arranged between the first side of the at least one coil and the cover plate, the shield layer being arranged to contact the cover plate, wherein the shield layer is configured to maintain the cover plate at a substantially uniform cover plate temperature; and
a coolant supply, the coolant supply being arranged to provide a coolant to the second side of the at least one coil, wherein the coolant supply provides the coolant at a coolant temperature, the coolant temperature being approximately lower than the substantially uniform cover plate temperature.

2. The motor arrangement of claim 1 wherein the shield layer includes a mixture of liquid and gas.

3. The motor arrangement of claim 1 wherein the shield layer includes a substantially laminar flow of liquid coolant, and wherein a portion of the shield layer that contacts the cover plate is maintained at a substantially constant shield layer temperature.

4. The motor arrangement of claim 1 wherein the coolant supply adjusts the coolant temperature of the coolant according to a amount of heat dissipated in the at least one coil.

5. The motor arrangement of claim 1 wherein the cover plate has a first surface and a second surface, the second surface being arranged to contact a top surface of the shield layer, the top surface including a liquid and a gas, and wherein the liquid and the gas further cause the first surface of the cover plate to have the substantially uniform cover plate temperature.

6. The motor arrangement of claim 1 wherein the coolant supply includes a first coolant supply, the first coolant supply being configured to provide a first coolant to the at least one coil from the second side of the at least one coil.

7. The motor arrangement of claim 6 wherein the at least one coil includes an active coil and an inactive coil, and the first coolant supply is further configured to provide the first coolant to the active coil and a second coolant to the inactive coil.

8. The motor arrangement of claim 7 wherein the first coolant and the second coolant have approximately a same chemical composition, and wherein the first coolant has a lower temperature than the second coolant.

9. The motor arrangement of claim 6 further including:
a coolant remover, the coolant remover being arranged to remove the first coolant from the second side of the at least one coil.

10. The method of claim 6 wherein the coolant supply is arranged to control the temperature of the first coolant depending on a measurement of the coolant temperature after the first coolant is removed from the at least one coil.

11. The motor arrangement of claim 1 further including:
a shield layer coolant supply, the shield layer coolant supply being configured to provide the liquid and the gas to the top surface of the shield layer.

12. The motor arrangement of claim 1 wherein the at least one coil, the cover plate, and the shield layer are included in a planar motor.

13. The motor arrangement of claim 1 wherein the motor arrangement is a part of a stage apparatus.

14. An exposure apparatus comprising the stage apparatus of claim 13.

15. A wafer formed using the exposure apparatus of claim 14.

16. A method of cooling a motor, the motor having at least one coil having a first side and a backside, the motor further having a cover plate positioned at a distance from the first side of the at least one coil, the method comprising:
providing at least one coolant to the at least one coil, the at least one coolant being provided from the backside of the at least one coil, wherein the at least one coolant is provided at a coolant temperature, the coolant temperature being below a temperature of the cover plate;
providing a shield layer between the cover plate and the first side of the at least one coil, wherein the shield layer contacts a first surface of the cover plate and is arranged to cause a second surface of the cover plate to maintain an approximately uniform temperature.

17. The method of claim 16, wherein the shield layer includes a mixture of liquid and gas.

18. The method of claim 16, wherein the shield layer includes a substantially laminar flow of liquid coolant, and wherein a portion of the shield layer that contacts the cover plate is maintained at a substantially constant shield layer temperature.

19. The method of claim 16, wherein the coolant temperature is actively controlled depending on an amount of heat dissipated in the at least one coil.

20. The method of claim 16 further including:
removing the at least one coolant, wherein removing the at least one coolant includes removing the at least one coolant from the backside of the at least one coil.

21. The method of claim 16 wherein the at least one coil includes an active coil and an idle coil, the method further including:
identifying the active coil; and
identifying the inactive coil, wherein providing the at least one coolant to the at least one coil includes providing a first coolant to the active coil and providing a second coolant to the inactive coil.

22. The method of claim 21 wherein the first coolant has a first temperature and the second coolant has a second temperature, the first temperature being lower than the second temperature.

23. The method of claim 16 wherein the at least one coolant is a liquid coolant.

24. The method of claim 16 wherein the motor is a planar motor.

25. The method of claim 16 wherein the planar motor is included in a lithography system.

26. The method of claim 25 further including:
forming a device using the lithography system.
